(19) United States
(12) Patent Application Publication
(10) Pub. No.: US 2024/0329701 A1
(43) Pub. Date: Oct. 3, 2024

(54) COMMUNICATION SYSTEM FOR DISPLAY CARD AND POWER SUPPLY

(71) Applicant: EVGA CORPORATION, New Taipei City (TW)

(72) Inventor: Tai-Sheng Han, New Taipei City (TW)

(21) Appl. No.: 18/126,986

(22) Filed: Mar. 27, 2023

(51) Int. Cl. G06F 1/18

(52) U.S. Cl. CPC G06F 1/189; H01R 13/6272; H01R 24/28; H01R 2107/00

(57) ABSTRACT

The communication system includes a display card, a display processing module, a display-card connector, a power supply, a power processing module, a signal transmission element, a display-end connector, and a configuration unit. The display-card connector includes a display-card first terminal set involving 6 terminals, a display-card second terminal set involving another 6 terminals, and a display-card signal terminal set including two function terminals and two detection terminals. Each function terminal allows at least one user-defined function regarding a signal to be monitored from the power supply. The display processing module, therefore, may monitor and control the power supply through the function terminals.

### BACKGROUND OF THE INVENTION

### (a) Technical Field of the Invention

The present invention is generally related to display cards and power supplies, and more particular to a communication system allowing a display card to monitor and communicate with the power supply.

### (b) Description of the Prior Art

A display card is a vital component for connecting a computer and a display. In recent years, the display card has become more powerful to process a greater amount of data. As such, the display card requires more wattage from the power supply, and the connector to the power supply also involve more pins.

To monitor the status of the power supply by the display card, there are teachings about configurating a USB cable between the power supply and the mother board of the computer. Through the USB cable, the display card is able to communicate with and monitor the status of the power supply. However, this type of communication between the power supply and the display card has to run through the mother board, where longer delay and less responsiveness would be expected. A longer USB cable is also required, implying a higher cost.

R.O.C. Taiwan Patent No. M577528 teaches a direct communication means between the power supply and the display card without going through the mother board. This teaching adopts an ordinary 6- or 8-pin PCIE connector and, when more power is required, two 6- or 8-pin PCIE connectors would be employed. This is obviously not an efficient approach in terms of PICE resource utilization.

Recently, Intel has proposed 16-pin power cables to offer more wattage and these cables have been utilized on display cards. However, these cables can only be used for power transmission only.

### SUMMARY OF THE INVENTION

A major objective of the present invention is to include function terminals in the cable connecting the display card and the power supply so that the display card may control and monitor the power supply.

The communication system includes a display card, a power supply, a signal transmission element, and a configuration unit. The display card has a display processing module and a display-card connector. The display-card connector includes a display-card first terminal set involving 6 terminals, a display-card second terminal set involving another 6 terminals, and a display-card signal terminal set including two function terminals and two detection terminals. The power supply has a power processing module connected to the display processing module via the signal transmission element. The signal transmission element has a display-end connector connecting and communicating with the display-card connector in a same protocol. The configuration unit is data-linked with the power processing module and the display processing module, and allows user-defined functions on the function terminals regarding the signals to be monitored from the power supply.

As described, through the configuration unit, a user may define the various conditions, such as overheating, power overloading, or safety, etc., to be monitored from the power supply. Then, the various signals may be passed through the function terminals so as to monitor or control the power supply. The present invention, therefore, obviates the shortcomings of the prior arts, which require two 6- or 8-pin PCIE connectors for increased power, or a single 16-pin power cable that can only be used for power transmission only.

The foregoing objectives and summary provide only a brief introduction to the present invention. To fully appreciate these and other objects of the present invention as well as the invention itself, all of which will become apparent to those skilled in the art, the following detailed description of the invention and the claims should be read in conjunction with the accompanying drawings. Throughout the specification and drawings identical reference numerals refer to identical or similar parts.

Many other advantages and features of the present invention will become manifest to those versed in the art upon making reference to the detailed description and the accompanying sheets of drawings in which a preferred structural embodiment incorporating the principles of the present invention is shown by way of illustrative example.

### BRIEF DESCRIPTION OF THE DRAWINGS

FIG. 1 is a perspective diagram showing the first embodiment of the present invention.

FIG. 2 is a perspective diagram showing a display-card connector and a display-end connector of the first embodiment of the present invention.

FIG. 3 is a functional block diagram showing the first embodiment of the present invention.

FIG. 4 is a perspective diagram showing a configuration unit of the first embodiment of the present invention.

FIG. 5 is a perspective diagram showing a power supply status displayed by the first embodiment of the present invention.

FIG. 6 is a perspective diagram showing a power supply status displayed by the second embodiment of the present invention.

FIG. 7 is a perspective diagram showing a third embodiment of the present invention.

FIG. 8 is a perspective diagram showing a fourth embodiment of the present invention.

FIG. 9 is a perspective diagram showing a fifth embodiment of the present invention.

FIG. 10 is a perspective diagram showing a sixth embodiment of the present invention.

### DETAILED DESCRIPTION OF THE PREFERRED EMBODIMENTS

The following descriptions are exemplary embodiments only, and are not intended to limit the scope, applicability or configuration of the invention in any way. Rather, the following description provides a convenient illustration for implementing exemplary embodiments of the invention. Various changes to the described embodiments may be made in the function and arrangement of the elements described without departing from the scope of the invention as set forth in the appended claims.

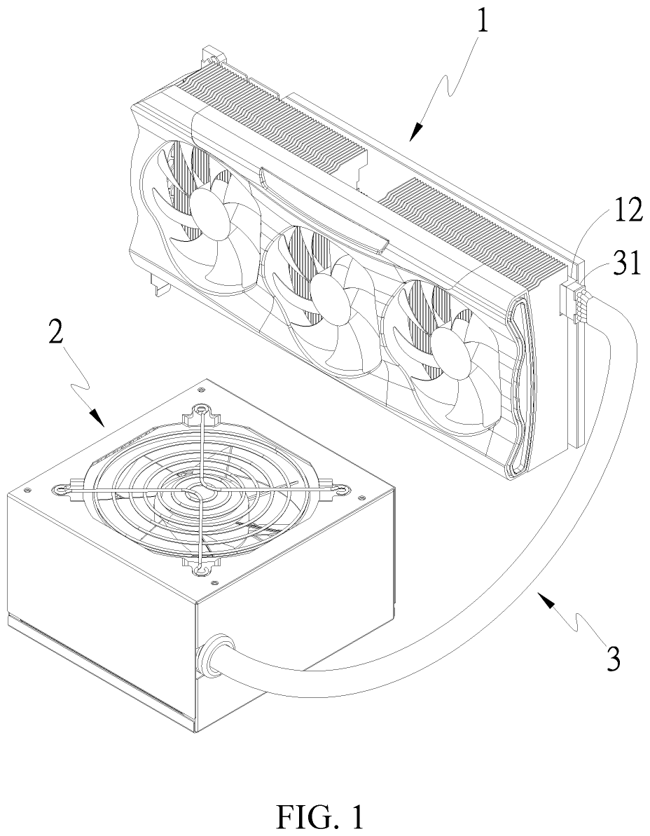

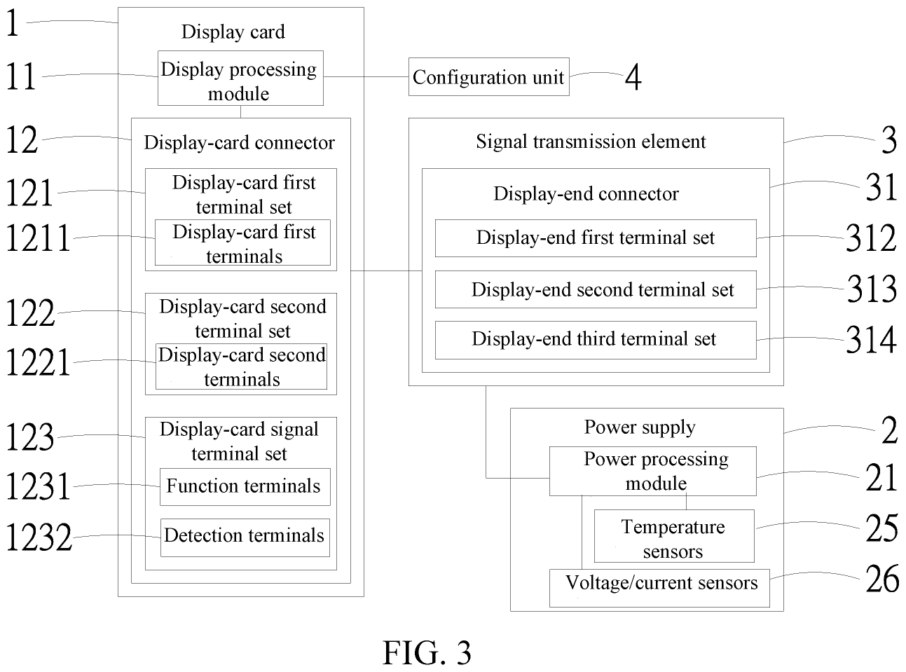

As shown in FIGS. 1 to 3, a first embodiment of the present invention includes:
a display card 1;
a display processing module 11 configured on the display card 1;
a display-card connector 12 configured on the display card 1 connected to the display processing module 11, where the display-card connector 12 includes a display-card first terminal set 121, a display-card second terminal set 122, and a display-card signal terminal set 123, the display-card first terminal set 121 includes six vertically aligned display-card first terminals 1211, the display-card second terminal set 122 includes six vertically aligned display-card second terminals 1221, each adjoining a corresponding display-card first terminal 1211, the display-card signal terminal set 123 includes two function terminals 1231 and two detection terminals 1232, vertically aligned adjoining and along a side of the display-card second terminal set 122 away from display-card first terminal set 121, and each function terminal 1231 allows a user-defined function;
a power supply 2 at a side to the display card 1;
a power processing module 21 in the power supply 2 connected to the display processing module 11;
a signal transmission element 3 having one end connected to the power processing module 21, and the other end configured with a display-end connector 31 connecting to and communicating with the display-card connector 12 through a same protocol. In the present embodiment, the display-end connector 31 includes a display-end first terminal set 312 having terminals respectively connecting the display-card first terminals 1211, a display-end second terminal set 313 having terminals respectively connecting the display-card second terminals 1221, and a display-end third terminal set 314 having terminals respectively connecting the function terminals 1231 and the detection terminals 1232; and
a configuration unit 4 data-linking the display processing module 11 and the power processing module 21, where the configuration unit 4 allows a user to define the signals to be monitored from the power supply 2 and, as such, the display processing module 11 may monitor and control the power supply 2 according to the signals received through the function terminals 1231.

In the present embodiment, the display card 1 includes multiple registers, respectively storing the statuses of the user-defined signals.

In the present embodiment, the display-card first terminals 1211 are ground terminals.

In the present embodiment, the display-card second terminals 1221 are power terminals.

In the present embodiment, the display processing module 11 is a graphic processing unit (GPU).

In the present embodiment, the display-card connector 12 are a female socket conforming to the PCIE 12VHPWR standard.

In the present embodiment, the power processing module 21 is a microcontroller unit (MCU).

In the present embodiment, the signal transmission element 3 is a power cable, and the display-end connector 31 is a male plug conforming to the PCIE 12VHPWR standard.

Additionally, the main purpose of the detection terminals 1232 is to provide the highest power level to the display card 1 to enhance the display card 1's stability.

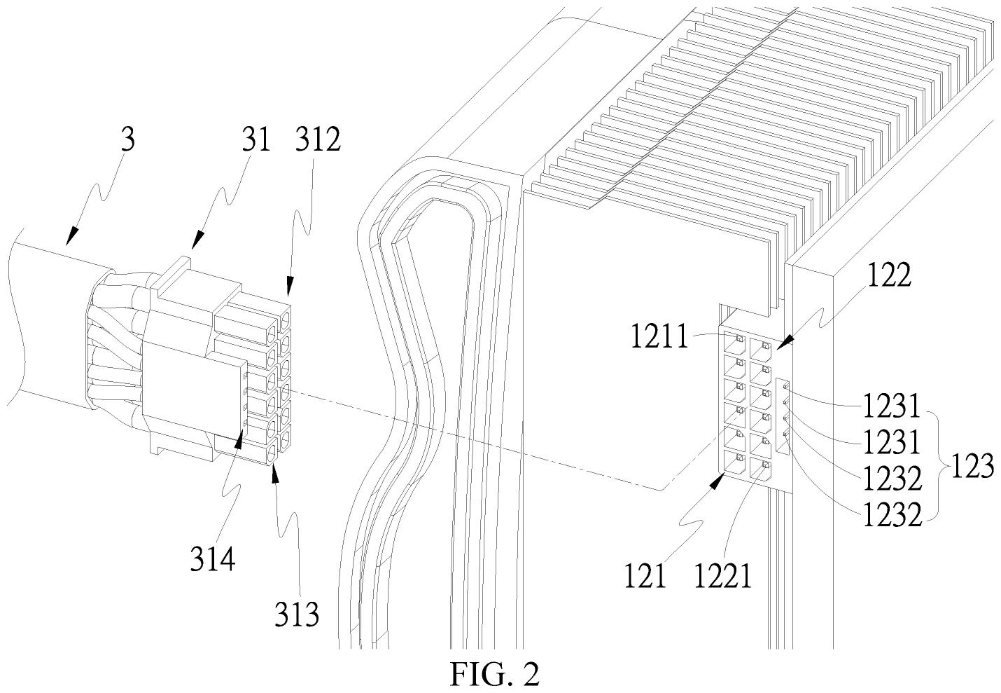

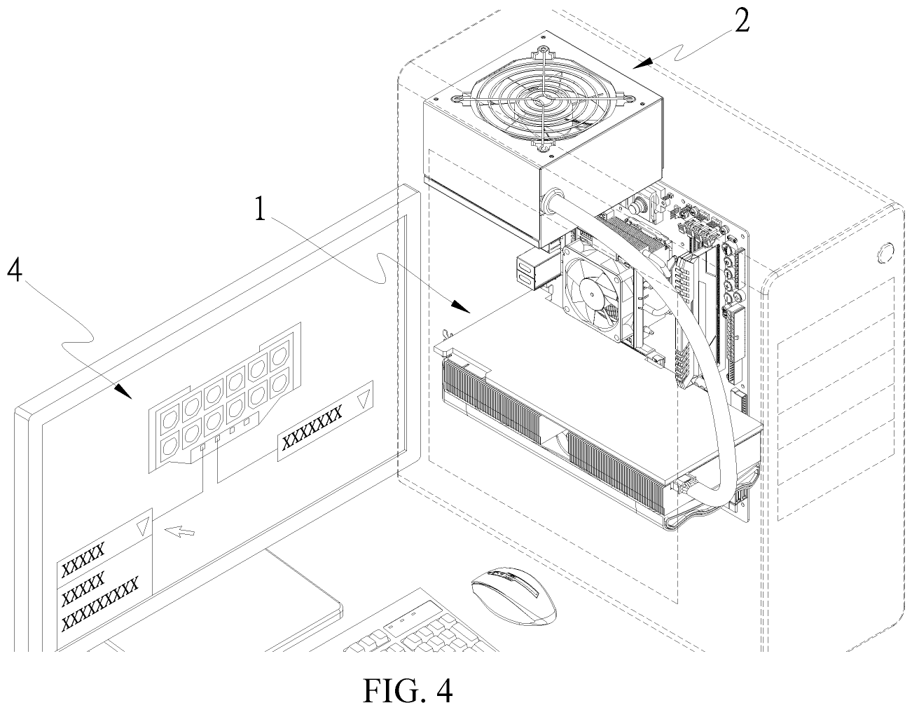

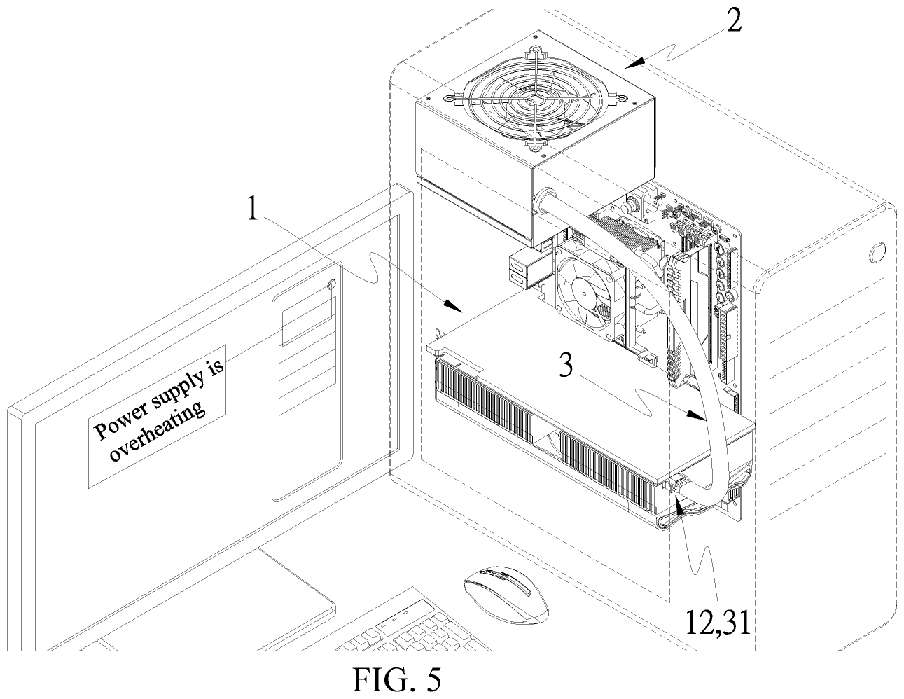

As shown in FIGS. 2 to 5, the gist of the present invention lies in the function terminals 1231's user-defined functions which serves as a bridge between the display card 1 and the power supply 2. The user-defined functions are configured through the configuration unit 4, which is a software application data-linked with the power processing module 21 and is capable of monitoring the power supply 2. The configuration unit 4 is able to display various messages on a computer display. For example, as shown in FIG. 4, the various conditions of the power supply 2, such as overheating, power overloading, and safety, to be monitored by the display card 1 is configured through the configuration unit 4, and the configuration parameters are stored in the registers. When the power supply 2 overheats, as shown in FIGS. 2, 3, and 5, this condition is detected by the power processing module 21 by comparing the power suppl 2's temperature with a threshold stored in a register, and the power processing module 21 notifies the display processing module 11 through the function terminals 1231 of display-card connector 12, the display-end connector 31, and the signal transmission element 3. The configuration unit 4 pops up a message window on the computer display reminding user that the power supply 2 is currently overheating. This anomaly condition of the power supply 2, as such, can be promptly noticed by the user and handled.

In addition, to achieve the overheating detection mentioned above, one or more temperature sensors 25 are configured inside the power supply 2 to sense the internal temperature of the power supply 2. When the temperature sensors 25 detects an anomalous high temperature, the power processing module 21 notifies the display processing module 11 and the configuration unit 4 through the function terminals 1231 of the display-card connector 12 and the display-end connector 31. Furthermore, power overloading detection can be achieved similarly by configuring one or more voltage/current sensors 26 inside the power supply 2. The voltage/current sensors 26 transmit the detected voltage/current values of the power supply 2 to the power processing module 21, which converts them into wattage. If there is a power overloading condition, the power processing module 21 notifies the display processing module 11 and the configuration unit 4 through the function terminals 1231 of the display-card connector 12 and the display-end connector 31.

In addition to that the display card 1 may monitor the power supply 2 through the function terminals 1231, the power supply 2 may provide stable and large amount of electricity through the display-card first terminal set 121's display-card first terminals 1211 and the display-card second terminal set 122's display-card second terminals 1221. The detection terminals 1232 also allow the power supply 2 to provide various output power, so that the display card 1 may obtain the highest power level.

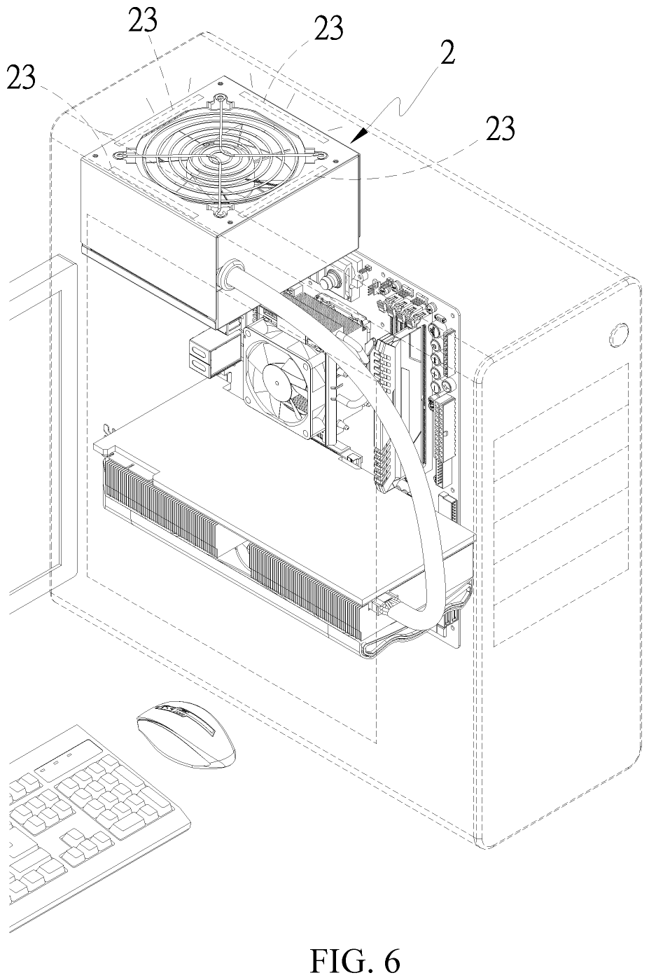

As shown in FIG. 6, a second embodiment of the present invention differs from the previous embodiment in that the power supply 2 includes a lighting element 23 to provide lighting effects. The configuration unit 4 may monitor or control the lighting element 23 through the function terminals 1231, so that the lighting element 23 may be activated when the power supply 2 operates or when some anomalous condition occurs to the power supply 2. The lighting element 23 may change light color or enter a flash mode to remind user of the anomalous condition, even when the user is not in front of the computer display.

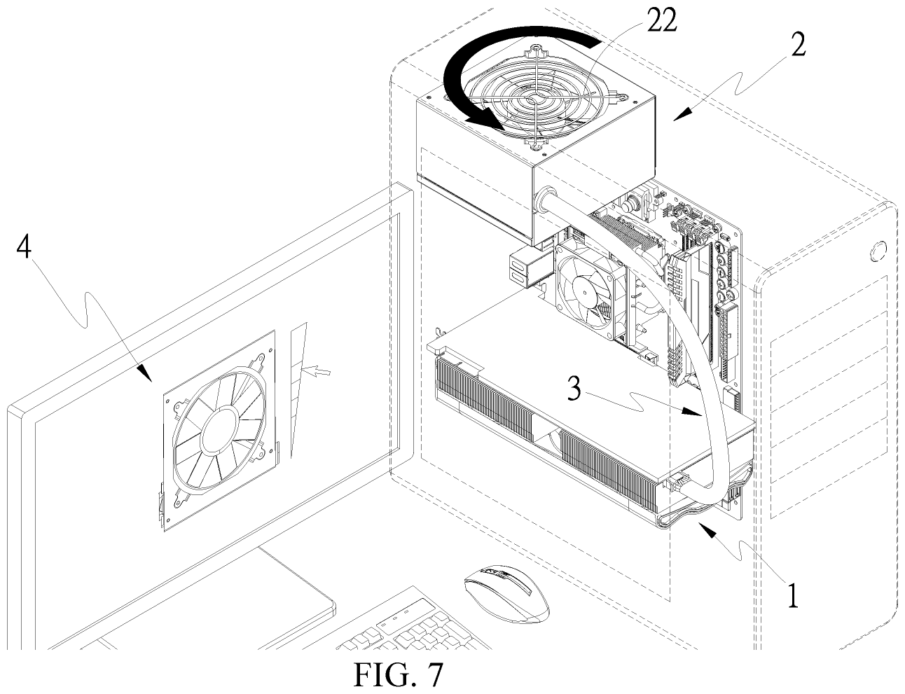

As shown in FIG. 7, the configuration unit 4 allows a user to define the various conditions such as overheating, power overload, safety, etc., to be monitored on the power supply 2. A third embodiment further allows the user to monitor or control a fan 22 of the power supply 2 through the configuration unit 4. In other words, the display card 1 can monitor or control the fan 22 of the power supply 2 through the function terminals 1231.

The status of the fan 22 can be passed to the display processing module 11 via the signal transmission element 3 and the user may be immediately notified of the status of the fan 22. For example, the function terminals 1231 may be defined to include the rotational speed of the fan 22. Then, a user may adjust the rotational speed of the fan 22 through the configuration unit 4, which instructs the power processing module 21 to set the rotational speed of the fan 22.

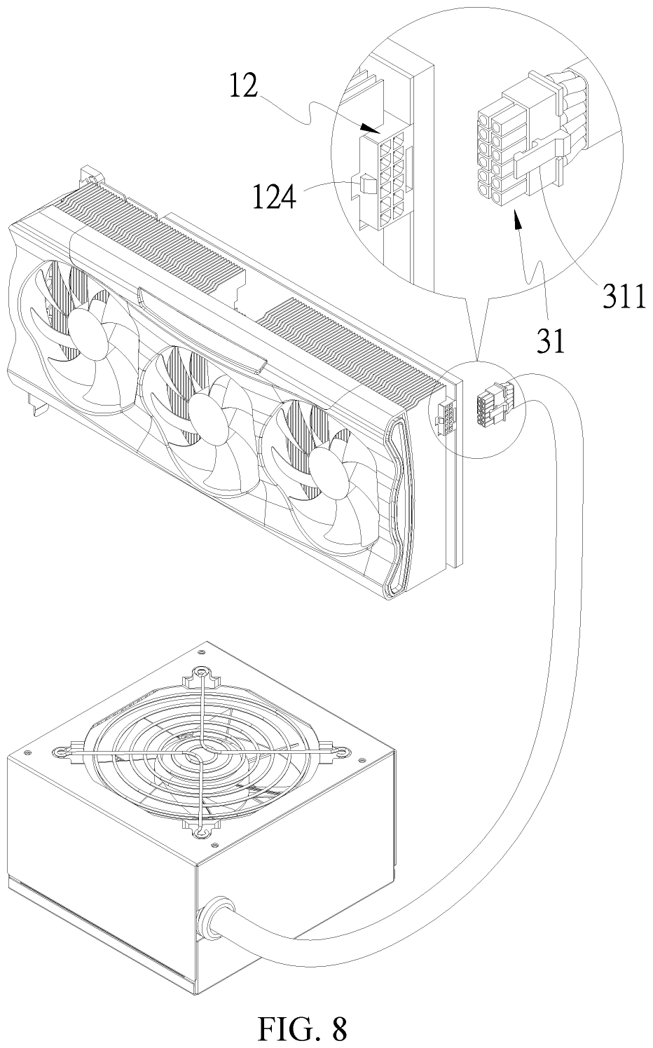

As shown in FIG. 8, a fourth embodiment of the present invention differs from the previous embodiments in that the display-end connector 31 has a first fastener 311 and the display-card connector 12 has a second fastener 124 for locking with the first fastener 311 so that the display-end connector 31 and the display-card connector 12 can be reliably connected.

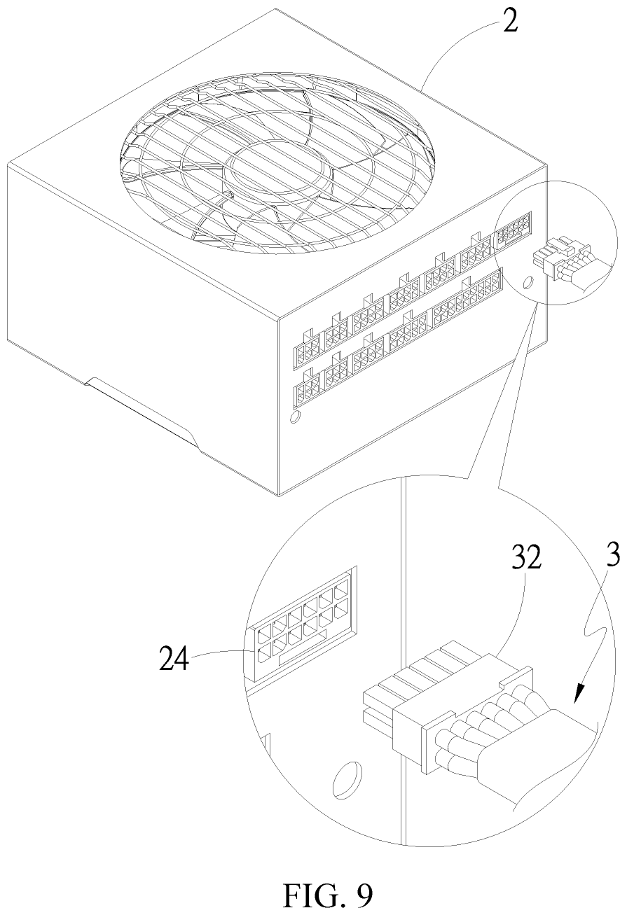

As shown in FIG. 9, a fifth embodiment of the present invention differs from the previous embodiments in that the signal transmission element 3, instead of fixedly connecting to the power processing module 21 of the power supply 2 in the previous embodiments, has a power-end connector 32 operating in the same protocol as the display-end connector, and the power supply 2 has a power connector 24 for plugging the power-end connector 32. The power connector 24 operates in the same protocol as the display-card connector. Therefore, by the detachable connection between the power-end connector 32 and the power connector 24, the display processing module 11 and the power processing module 21 may communicate with each other.

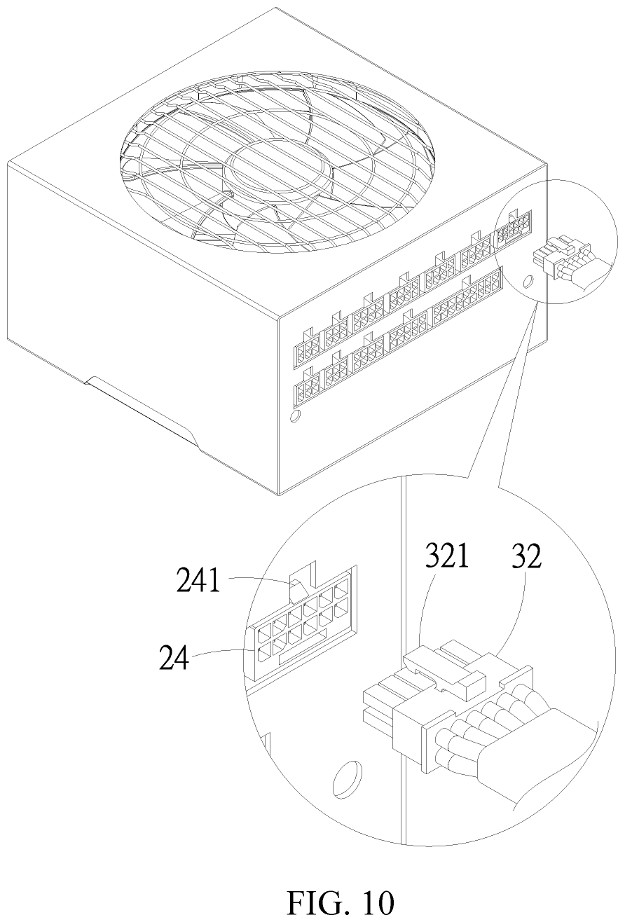

As shown in FIG. 10, a sixth embodiment of the present invention differs from the previous embodiments in that the power-end connector 32 has a third fastener 321, and the power connector 24 has a fourth fastener 241 for locking with the third fastener 321 so that the power-end connector 32 and the power connector 24 can be reliably connected.

As described above, the present invention provides improvements over the prior arts as follows.

First, through the user-defined functions over the two function terminals 1231 by the configuration unit 4, the 16-pin display-card connector 12 and display-end connector 31 also allows the display card 1 to monitor the power supply 2, in addition to power transmission. The use-defined functions may involve power supply 2's voltage, current, temperature, power loading, and the control to the lighting element 23 or the fan 22. However, these functions are exemplary only, the present invention is not limited as such, and additional functions about the power supply 2 may be defined.

Second, the display card 1 directly connects the power supply 2 through the signal transmission element 3 without going through the motherboard. With the reduced signal path, the display card 1 may be more responsive to the statuses of the power supply 2.

Third, the present invention relies on a signal transmission element 3 to provide large voltage, large current, and signal transmission simultaneously without using separate power and signal cables, thereby achieving cost reduction.

Fourth, through the fasteners 311, 321, 124, and 241, the signal transmission element 3 is more reliably connected to the display card 1 and the power supply 2.

Fifth, the lighting element 23 on the power supply 2 not only provides appealing visual effects, but also may be used as an indicator for power supply 2's anomalous condition.

While certain novel features of this invention have been shown and described and are pointed out in the annexed claim, it is not intended to be limited to the details above, since it will be understood that various omissions, modifications, substitutions and changes in the forms and details of the device illustrated and in its operation can be made by those skilled in the art without departing in any way from the claims of the present invention.

I claim:

1. A communication system for display card and power supply, comprising:
a display card;
a display processing module configured on the display card;
a power supply at a side to the display card;
a display-card connector configured on the display card connected to the display processing module, where the display-card connector comprises a display-card first terminal set, a display-card second terminal set, and a display-card signal terminal set, the display-card first terminal set comprises six vertically aligned display-card first terminals, the display-card second terminal set comprises six vertically aligned display-card second terminals, each adjoining a corresponding display-card first terminal, the display-card signal terminal set comprises two function terminals and two detection terminals, vertically aligned adjoining and along a side of the display-card second terminal set away from display-card first terminal set, and each function terminal allows at least one user-defined function regarding a signal to be monitored from the power supply;
a power processing module in the power supply connected to the display processing module;
a signal transmission element having a first end connected to the power processing module, and a second end configured with a display-end connector connecting to and communicating with the display-card connector through a same protocol; and
a configuration unit data-linking the display processing module and the power processing module, where the configuration unit allows a user to define the at least one user-defined function and, as such, the display processing module is capable of monitoring and controlling the power supply according to signals received through the function terminals.

2. The communication system according to claim 1, wherein the signal transmission element has a power-end connector at the first end operating in a same protocol as the display-end connector, the power supply has a power connector for plugging the power-end connector, the power connector operates in the same protocol as the display-card connector, and, by the detachable connection between the power-end connector and the power connector, the display processing module and the power processing module are capable of communicating with each other.

3. The communication system according to claim 2, wherein the power-end connector has a third fastener, and the power connector has a fourth fastener for locking with the third fastener.

4. The communication system according to claim 1, wherein the display-end connector has a first fastener, and the display-card connector has a second fastener for locking with the first fastener.

5. The communication system according to claim 1, wherein at least one user-defined function is one of the power supply's overheating detection, power loading detection, safety detection, fan control, and lighting control.

6. The communication system according to claim 1, wherein the display-card first terminals are ground terminals.

7. The communication system according to claim 1, wherein the display-card second terminals are power terminals.

8. The communication system according to claim 1, wherein the detection terminals provide the highest power level to the display card to enhance the display card's stability.

9. The communication system according to claim 1, further comprising a lighting element disposed on the power supply.
